(19) United States
(12) Patent Application Publication
(10) Pub. No.: US 2010/0092271 A1
(43) Pub. Date: Apr. 15, 2010

(54) Revolving trailer for motorcycles

(76) Inventors: Arthur C. Richardson, Anthony, FL (US); James H. Johnson, Debary, FL (US)

Correspondence Address: LITMAN LAW OFFICES, LTD., POST OFFICE BOX 41200, SOUTH STATION, ARLINGTON, VA, 22204, US

(21) Appl. No.: 12/585,760

(22) Filed: Sep. 24, 2009

Related U.S. Application Data
(60) Provisional application No. 61/136,866, filed on Oct. 9, 2008.

(51) Int. Cl. B60P 3/07; B60P 1/43; B60P 1/64

(52) U.S. Cl. 414/537; 280/400

(57) ABSTRACT

The revolving trailer for motorcycles is a portable trailer for transporting and supporting motorcycles. The revolving trailer includes a rotating platform, allowing a motorcycle mounted thereon to be rotated 180° so that the motorcycle can be driven off of the trailer, rather than having to be backed off of the trailer. The trailer includes a base, with a recess being formed in an upper surface thereof. The base has a central opening formed therethrough. The platform is mounted for rotation within the recess. An upper surface of the rotating platform is coplanar with the upper surface of the base, allowing the motorcycle to be smoothly driven onto and off of the rotating platform. A central opening is formed through the rotating platform. A central shaft or pivot pin extends through the central openings to secure the platform within the recess.

### CROSS-REFERENCE TO RELATED APPLICATION

This application claims the benefit of U.S. Provisional Patent Application Ser. No. 61/136,866, filed Oct. 9, 2008.

### BACKGROUND OF THE INVENTION

1. Field of the Invention

The present invention relates to vehicle trailers, and particularly to a revolving trailer for motorcycles that provides a trailer having a platform that at least one motorcycle can be secured on, the platform being rotatable at least 180°.

2. Description of the Related Art

Transport trailers are commonly used to transport small vehicles, such as motorcycles. Conventionally, the motorcycle is driven or positioned on the platform of the transport trailer in a forward orientation. Unloading the motorcycle is conventionally by manually backing the motorcycle off of the trailer and down a ramp. Because motorcycles are not provided with a reverse gear, the motorcycle must be manually rolled backwards, which is sometimes difficult or dangerous for the driver and others around the trailer, particularly when the driver must maintain his or her balance on the trailer. Thus, a revolving trailer for motorcycles solving the aforementioned problems is desired.

### SUMMARY OF THE INVENTION

The revolving trailer for motorcycles is a portable trailer for transporting and supporting motorcycles. The revolving trailer includes a rotating platform, thus allowing a motorcycle mounted thereon to be rotated 180° so that the motorcycle can be driven off of the trailer, rather than having to be backed off of the trailer, as with conventional motorcycle transports.

The revolving trailer for motorcycles includes a base having opposed upper and lower surfaces, with a recess being formed in the upper surface. The base preferably has a central opening formed therethrough. The rotating platform is rotatably received within the recess in the base. An upper surface of the rotating platform is substantially coplanar with the upper surface of the base, allowing the motorcycle to be smoothly driven onto and off of the rotating platform. A central opening is also preferably formed through the rotating platform.

A pivot pin, shaft or the like extends through the central opening formed in the base and the central opening formed in the rotating platform. The pivot pin rotatably secures the rotating platform within the recess formed in the base. A plurality of wheels are rotatably mounted to the lower surface of the base, as in a conventional trailer.

These and other features of the present invention will become readily apparent upon further review of the following specification and drawings.

### BRIEF DESCRIPTION OF THE DRAWINGS

FIG. 1 is an environmental, perspective view of a revolving trailer for motorcycles according to the present invention.

FIG. 2 is an environmental, perspective view of the revolving trailer for motorcycles according to the present invention, showing the rotating platform partially rotated.

FIG. 3 is an environmental, perspective view of the revolving trailer for motorcycles according to the present invention, showing the rotating platform rotated 180° from the orientation of FIG. 1.

FIG. 4 is a top view of the revolving trailer for motorcycles according to the present invention.

FIG. 5 is a bottom view of the revolving trailer for motorcycles according to the present invention.

Similar reference characters denote corresponding features consistently throughout the attached drawings.

### DETAILED DESCRIPTION OF THE PREFERRED EMBODIMENTS

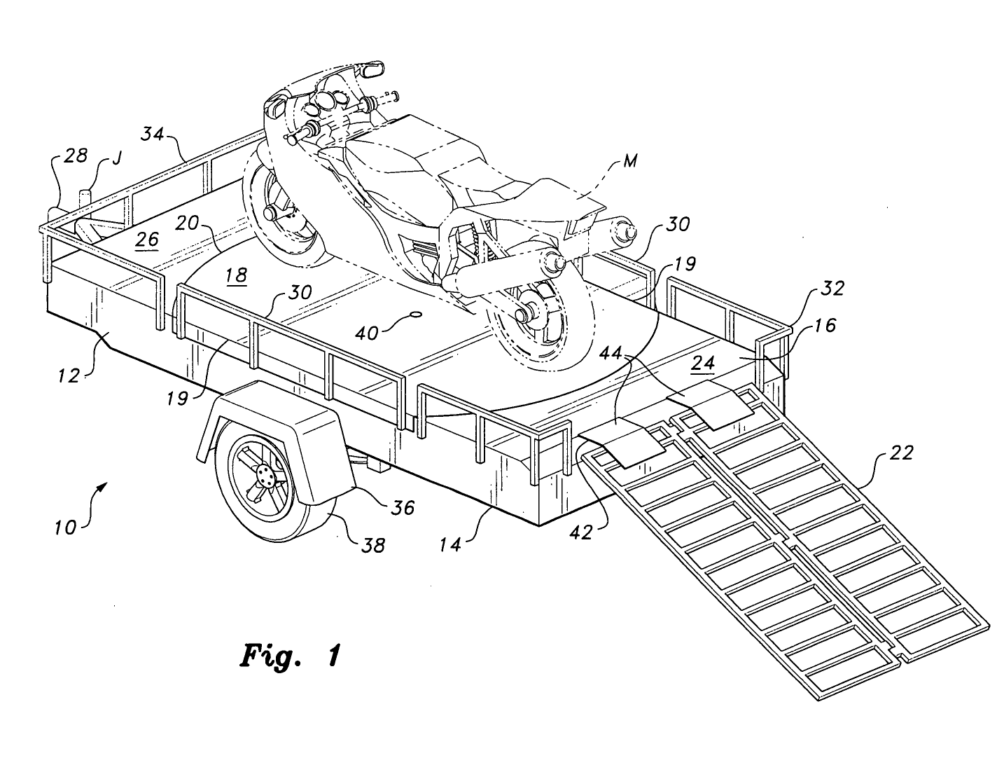

As best shown in FIG. 1, the revolving trailer for motorcycles, designated generally as 10 in the drawings, includes a base 12 having opposed planar upper and lower surfaces 16, 14, respectively. A recess 20 is formed in the upper surface 16 of base 12 for receiving a central, rotating platform 18. An exemplary motorcycle M is positioned on the rotating platform 18. The base 12 includes a front portion 26, having a trailer hitch 28 secured thereto. Trailer hitch 28 is adapted for releasable attachment to the hitch of a truck or the like, or to a jack, such as exemplary hydraulic jack J, shown in FIGS. 1-3. It should be understood that any suitable type of trailer hitch may be utilized.

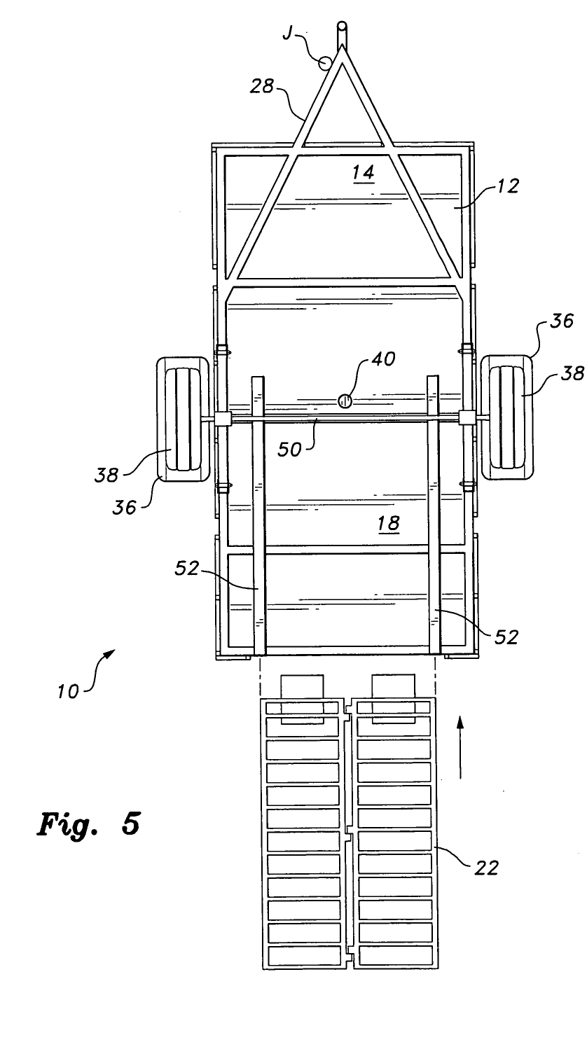

The base 12 further includes a rear portion 24. A pair of wheels 38 are rotatably mounted to a conventional trailer chassis, suspension system and axle 50 below the lower surface 14 of base 12, as best shown in FIG. 5, with wheels 38 being mounted within a pair of wheel wells 36. Wheels 38 may be any suitable conventional trailer wheels, and may utilize any suitable, conventional rotational mounting. It should be understood that though the trailer 10 is shown as being used with exemplary motorcycle M, trailer 10 may be used to transport any desired vehicle, such as a snowmobile, for example. Similarly, trailer 10 may be used as a conventional utility trailer, if so desired. It should be understood that motorcycle M is shown for exemplary purposes only, and is not intended to limit the functionality of the inventive trailer 10.

Although the trailer 10 may have any suitable dimensions, exemplary dimensions of a suitable single axle trailer 10 include a longitudinal length of approximately ten feet, and a lateral width of approximately five feet. The rotating platform 18 has a maximum radius (measured along the longitudinal direction in FIG. 1) of approximately four feet. The width (measured along the lateral direction in FIG. 1) of the rotating platform 18 matches the width of the base 12; i.e., approximately five feet. For a dual axle trailer adapted for transport of multiple motorcycles, the trailer 10 may include a longitudinal length of approximately twelve feet and a lateral width of approximately eight feet.

As shown in FIGS. 1-3, rails 34 may be provided on front portion 26, and rails 32 may be provided on rear portion 24, providing safe and stable grips for the users. Further, rails 30 extend along the lateral edges 19 of rotating platform 18, as shown. In addition to providing a safety barrier for motorcycle M, the rails 30 provide a gripping surface or handle for rotation of rotating platform 18. It should be understood that rails 30, 32 and 34 are shown for exemplary purposes only, and that rails 30, 32 and 34 may comprise any suitable fencing or safety barriers.

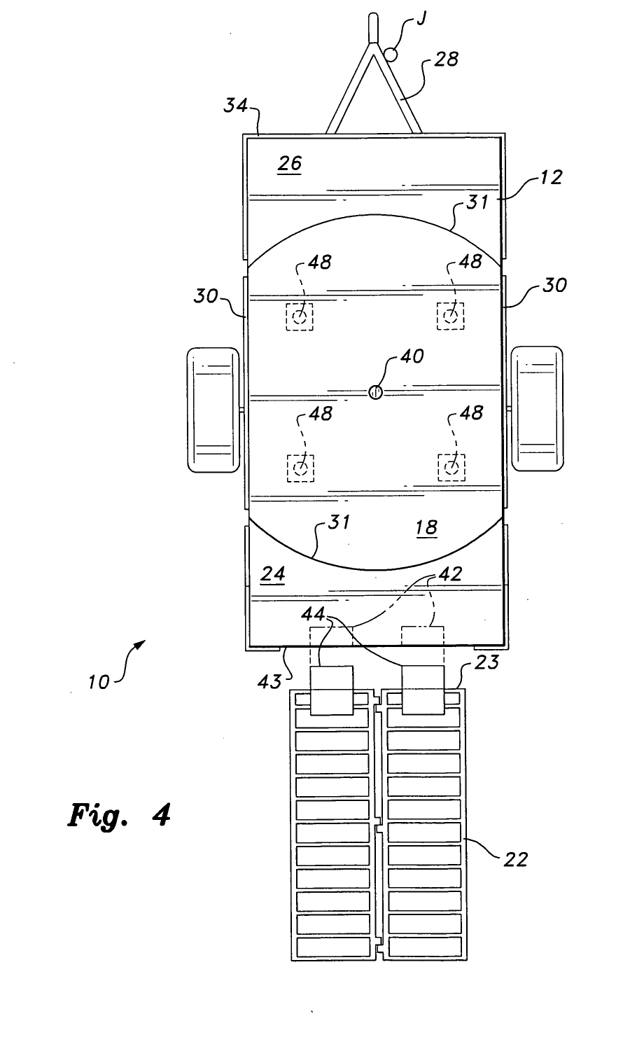

As shown in FIG. 4, the rotating platform 18 is received within the recess 20 of base 12, and rests on a plurality of bearings 48 (which may be any suitable bearings, including roller bearings, such as fiberglass roller bearings or the like), mounted to the trailer chassis. A central shaft, pivot pin 40 or the like rotatably attaches rotating platform 18 to base 12. Preferably, the rotating platform 18 and the base 12 have central openings formed therethrough, and the pivot pin 40 extends through these openings. The shaft or pivot pin 40 may be fixed with bearings journaled into the hub or central opening in the platform 18 so that the platform 18 rotates about the pin 40, or the platform 18 may be fixed to the shaft or pin 40, the pin 40 being rotatably mounted in suitable bearings. Although four roller bearings 48 are shown radially spaced from the hub in FIG. 4, it should be understood that this is for exemplary purposes only, and that any suitable number of roller bearings 48 may be used.

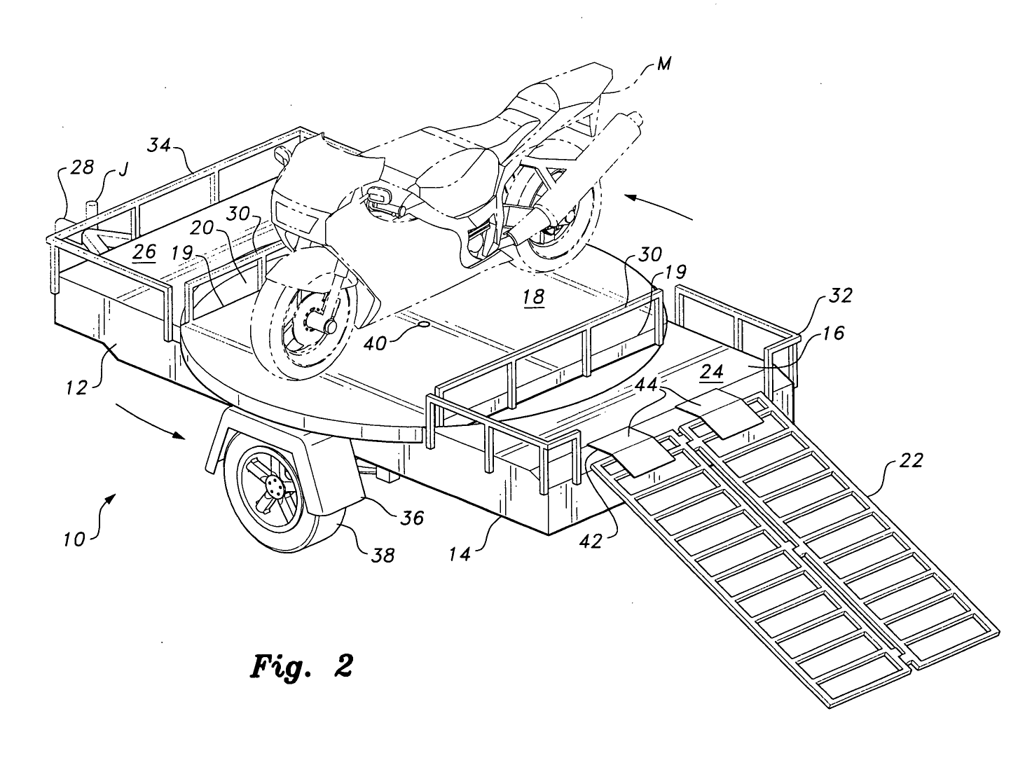

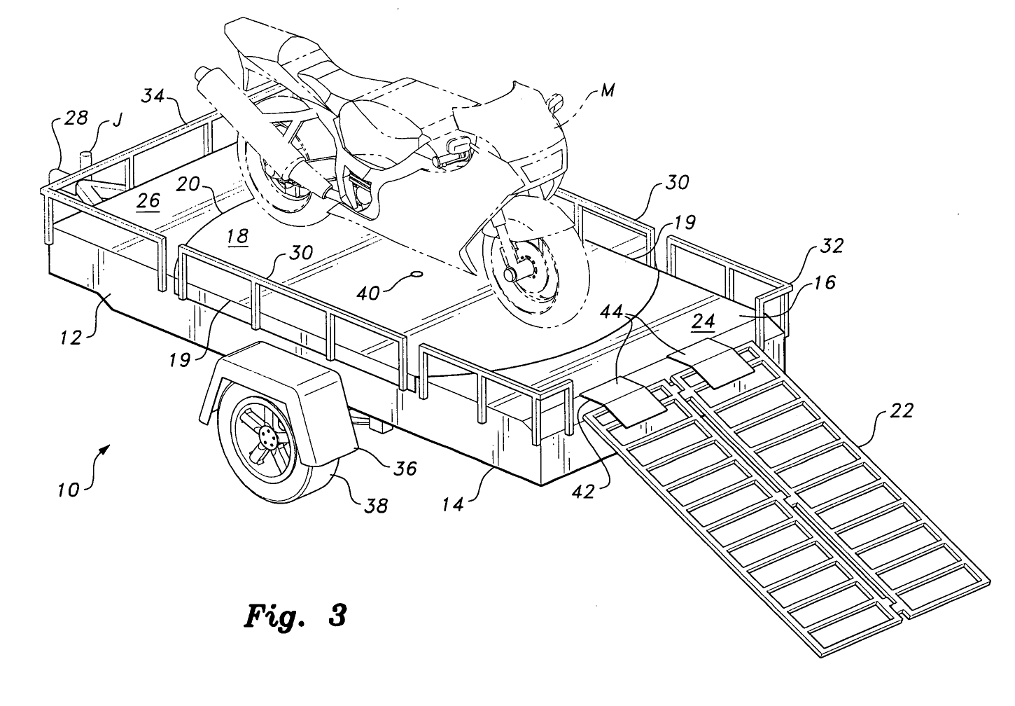

In use, the motorcycle M is positioned on rotating platform 18 in a forward position, having been driven onto the rotating platform 18 via the ramp 22, shown in FIG. 1. In order to remove the motorcycle M from trailer 18 without having to back the motorcycle M down the ramp 22 in the same orientation, the rotating platform 18 is rotated, as shown in FIG. 2, about pivot 40. FIG. 2 illustrates the rotating platform in a partial state of rotation (as indicated by the directional arrows). In FIG. 3, rotating platform 18 has been rotated 180° with respect to the original orientation of FIG. 1 (and with respect to the base 12), thus reversing the orientation of motorcycle M and allowing motorcycle M to be driven down ramp 22.

As shown in FIG. 2, due to the disparity in longitudinal length and lateral width (when viewed in the orientation of FIGS. 1 and 3) of the rotating platform 18, a pair of gaps are formed on either side of the rotating platform 18 when the platform 18 is in a state of partial rotation. The upper surface of the rotating platform 18 is coplanar with the upper surface of the base 12, allowing the motorcycle M to be smoothly driven onto and off of the rotating platform 18. The platform 18 may have at least one wheel chock or rack mounted on its upper surface to prevent the front wheel of the motorcycle M from pivoting when being transported on the trailer 10, and the motorcycle may be tethered to the platform 18 by load binders, ratcheting nylon straps, or other adjustable tether secured to rings mounted on the platform 18. The platform 18 itself may be locked against rotation when the motorcycle is being transported by any suitable form of latch or latch pin extending between the platform 18 and the base 12 or trailer chassis.

It should be understood that the shape of the rotating platform 18 (and the base 12) are shown here for exemplary purposes only, and that the dimensions and configuration of the platform 18 and the base 12 may vary within the scope of the invention as claimed. It will be understood that although the drawings show a single axle trailer with a single motorcycle mounted on platform 18, the trailer 10 may be a double axle trailer having a platform and chassis large enough to support two motorcycles. Arcuate edges 31 of the rotating platform 18 preferably each have a constant radius of curvature in order to provide smooth rotation and positioning of the platform 18.

The ramp 22 includes a plurality of engaging members 44 (shown in the drawings as an exemplary pair of hook members) extending from a forward edge 23 thereof for releasable engagement with a corresponding plurality of slots or recesses 42 formed in a rear edge 43 of the base 12. During transport, the ramp 22 is removed and may be stored beneath the base 12. As shown in FIG. 5, a pair of rails 52 may be secured to the lower surface 14 of base 12, the ramp 22 being slidably and removably received therebetween. It should be understood that any suitable type of releasable attachment may be used for securing the ramp 22 to the rear edge 43 of the base 12, and further for releasably securing the ramp 22 to the base 12 for storage and transport. It should be understood that the trailer configuration illustrated in the Figures may be varied without departing from the spirit or scope of the invention as claimed. For example, the trailer may be an enclosed trailer. Additionally, the additional elements not related to the centrally rotating hub may be varied, dependent upon the particular needs and desires of the user. For example, the height of the rails may be varied, or as another example, the rear rails may be removed. Additional elements commonly associated with trailers may also be added, such as a front wall or windshield, for example.

It is to be understood that the present invention is not limited to the embodiment described above, but encompasses any and all embodiments within the scope of the following claims.

We claim:

1. A revolving trailer for motorcycles, comprising:
a trailer chassis having a plurality of ground-engaging wheels rotatably mounted thereon;
a base mounted on the trailer chassis, the base having opposed upper and lower surfaces, a recess being formed in the upper surface;
a shaft attached to the chassis, the shaft extending through the base;
a platform having a central opening defining a hub, the hub being mounted on the shaft, the platform having an upper surface substantially coplanar with the upper surface of the base, the platform being dimensioned and configured for mounting a motorcycle thereon for transport; and
a plurality of bearings attached to the chassis, the bearings being radially spaced, the platform being mounted for rotation on the bearings, the platform being rotatable at least 180°.

2. The revolving trailer for motorcycles as recited in claim 1, wherein the recess is formed substantially centrally along a longitudinal axis of said base.

3. The revolving trailer for motorcycles as recited in claim 2, wherein the recess is defined by a pair of longitudinally opposed edges of the upper surface of said base and a pair of laterally opposed edges of the upper surface of said base, each of the longitudinally opposed edges being arcuate and each of the laterally opposed edges being substantially linear.

4. The revolving trailer for motorcycles as recited in claim 3, wherein each of the longitudinally opposed edges of the upper surface of said base defining the recess has a substantially constant radius of curvature.

5. The revolving trailer for motorcycles as recited in claim 4, wherein said platform has a pair of longitudinally opposed platform edges and a pair of laterally opposed platform edges, each of the longitudinally opposed platform edges being arcuate and each of the laterally opposed platform edges being substantially linear.

6. The revolving trailer for motorcycles as recited in claim 5, wherein each of the longitudinally opposed platform edges has a substantially constant radius of curvature.

7. The revolving trailer for motorcycles as recited in claim 6, wherein said platform has a lateral width substantially equal to said base.

8. The revolving trailer for motorcycles as recited in claim 7, further comprising a pair of platform rails mounted on an upper surface of said platform, the platform rails being positioned respectively adjacent the pair of laterally opposed platform edges.

9. The revolving trailer for motorcycles as recited in claim 8, further comprising a front rail mounted on the upper surface of said base adjacent a front edge thereof.

10. The revolving trailer for motorcycles as recited in claim 9, further comprising a pair of rear rails mounted on the upper surface of said base adjacent a rear edge thereof, the pair of rear rails being positioned laterally opposite one another and being laterally spaced apart with respect to one another to define an open path for a motorcycle therebetween.

11. The revolving trailer for motorcycles as recited in claim 1, further comprising a trailer hitch secured to a front portion of said trailer chassis.

12. The revolving trailer for motorcycles as recited in claim 11, further comprising a ramp releasably secured to a rear portion of said base.

13. The revolving trailer for motorcycles as recited in claim 12, wherein the ramp has a plurality of engaging members mounted on a front edge thereof for releasably engaging a corresponding plurality of slots formed in the rear portion of said base.

14. A revolving trailer for motorcycles, comprising:
a trailer chassis having a plurality of ground-engaging wheels rotatably mounted thereon;
a base mounted on the trailer chassis, the base having opposed upper and lower surfaces, a recess being formed in the upper surface;
a front rail mounted on the upper surface of the base adjacent a front edge thereof;
a pair of rear rails mounted on the upper surface of the base adjacent a rear edge thereof, the pair of rear rails being positioned laterally opposite one another and being laterally spaced apart with respect to one another to define an open path for a motorcycle therebetween;
a ramp releasably secured to a rear portion of the base, the ramp having a front edge releasably secured to the base between the pair of rear rails;
a shaft attached to the chassis, the shaft extending through the base;
a platform having a central opening defining a hub, the hub being mounted on the shaft, the platform having an upper surface substantially coplanar with the upper surface of the base, the platform being dimensioned and configured for mounting a motorcycle thereon for transport; and
a plurality of bearings attached to the chassis, the bearings being radially spaced, the platform being mounted for rotation on the bearings, the platform being rotatable at least 180°.

15. The revolving trailer for motorcycles as recited in claim 14, wherein the recess is formed substantially centrally along a longitudinal axis of said base.

16. The revolving trailer for motorcycles as recited in claim 15, wherein the recess is defined by a pair of longitudinally opposed edges of the upper surface of said base and a pair of laterally opposed edges of the upper surface of said base, each of the longitudinally opposed edges being arcuate and each of the laterally opposed edges being substantially linear.

17. The revolving trailer for motorcycles as recited in claim 16, wherein each of the longitudinally opposed edges of the upper surface of said base defining the recess has a substantially constant radius of curvature.

18. The revolving trailer for motorcycles as recited in claim 17, wherein said platform has a pair of longitudinally opposed platform edges and a pair of laterally opposed platform edges, each of the longitudinally opposed platform edges being arcuate and each of the laterally opposed platform edges being substantially linear.

19. The revolving trailer for motorcycles as recited in claim 18, wherein each of the longitudinally opposed platform edges has a substantially constant radius of curvature.

20. The revolving trailer for motorcycles as recited in claim 19, further comprising a pair of platform rails mounted on an upper surface of said platform, the platform rails being positioned respectively adjacent the pair of laterally opposed platform edges.
